(19) United States
(12) Patent Application Publication
(10) Pub. No.: US 2026/0031388 A1
(43) Pub. Date: Jan. 29, 2026

(54) FLUORINE-CONTAINING SOLID-STATE ELECTROLYTE AND PREPARATION METHOD THEREFOR, AND BATTERY

(71) Applicant: Eastern Institute for Advanced Study, Ningbo (CN)

(72) Inventors: Xiaona LI, Ningbo (CN); Xueliang SUN, Ningbo (CN); Simeng ZHANG, Ningbo (CN); Junyi YUE, Ningbo (CN)

(73) Assignee: Eastern Institute for Advanced Study, Ningbo (CN)

(21) Appl. No.: 19/283,477

(22) Filed: Jul. 29, 2025

(30) Foreign Application Priority Data
Jul. 29, 2024 (CN) 202411018427.4

(51) Int. Cl. H01M 10/0562

(52) U.S. Cl. CPC H01M 10/0562; H01M 2300/008

(57) ABSTRACT

The present disclosure relates to the technical field of battery materials, and provides a fluorine-containing solid-state electrolyte. The fluorine-containing solid-state electrolyte has a general structural formula (AX)ₐMB_{y}, where A denotes at least one of Li, Na, K, Ag, and Cu, M denotes at least one of Ti, Sn, Ta, Nb, Zr, Hf, Ga, Al, and Fe, and 0.5<a<4; B denotes F, X denotes at least one of an oxygen-containing anion and a fluorine-containing anion, and y equals 4 or 5; or B denotes at least one of F, Cl, Br, and I, X denotes BF₄, and y equals 3, 4, or 5. The solid-state electrolytes according to examples of the present disclosure have the high ionic conductivities.

### CROSS-REFERENCE TO RELATED APPLICATIONS

The application claims priority to Chinese patent application No. 202411018427.4, filed on Jul. 29, 2024, the entire contents of which are incorporated herein by reference.

### TECHNICAL FIELD

The present disclosure belongs to the technical field of battery materials, and particularly relates to a fluorine-containing solid-state electrolyte and a preparation method therefor, and a battery.

### BACKGROUND

To satisfy the demand of users for electronic products, the energy density of a battery is further enhanced to reduce the charge frequency of electric tools, mobile power supplies, etc., and prolong the service life of the battery. An increase in charge voltage of the battery is an important approach to enhancing the energy density. However, an increase in charge voltage also means a challenge to the oxidation stability of an electrolyte. A liquid electrolyte is limited by the oxidation limit of 4.3 V or so of carbonate ester solvents, and additives of an electrolyte solution can only slightly improve the resistance of the electrolyte solution to high voltage. With a wide electrochemical stability window, a fluoride solid-state electrolyte is expected to be compatible with a higher-voltage cathode and achieve an all-solid-state battery with higher energy density. However, the ionic conductivity of a fluoride electrolyte is typically 10⁻⁸ S cm⁻¹, which is difficult to satisfy the practical application demand. In consequence, no fluoride electrolyte suitable for an all-solid-state battery system has been available at present. It has become a pressing issue to develop a fluoride solid-state electrolyte with the high ionic conductivity.

### SUMMARY

An objective of the present disclosure is to provide a fluorine-containing solid-state electrolyte and a preparation method therefor, and a battery, so as to solve the low ionic conductivity of a fluoride electrolyte.

In order to realize the above objective, the present disclosure employs the technical solution as follows:

In an aspect, the present disclosure provides a fluorine-containing solid-state electrolyte. The fluorine-containing solid-state electrolyte has a general structural formula (AX)ₐMB_{y}, where A denotes at least one of Li, Na, K, Ag, and Cu, M denotes at least one of Ti, Sn, Ta, Nb, Zr, Hf, Ga, Al, and Fe, and 0.5<a<4; B denotes F, X denotes at least one of an oxygen-containing anion and a fluorine-containing anion, and y equals 4 or 5; or B denotes at least one of F, Cl, Br, and I, X denotes BF₄, and y equals 3, 4, or 5.

In a second aspect, the present disclosure provides a preparation method for a fluorine-containing solid-state electrolyte. The preparation method includes: performing a solid-phase reaction on AX powder and MB_{y} powder at a stoichiometric ratio through a mechanical ball milling method under an inert atmosphere without water and oxygen, so as to obtain a fluorine-containing solid-state electrolyte (AX)ₐMB_{y}.

In a third aspect, the present disclosure provides a battery. The battery includes the above fluorine-containing solid-state electrolyte.

According to the present disclosure, X anions are connected to transition metal-halogen ion polyhedra, so as to form an open frame structure, a crosslinked net-shaped framework and a penetrated-through three-dimensional channel are established, and vacancies are filled with A ions. Through such a design, the A ions can be rapidly conducted in a structure with a large free volume. The solid-state electrolyte, according to the examples of the present disclosure, has the high ionic conductivity. Fluorine ions have the high electronegativity (for example, the oxidation potential limit of a perfluorinated electrolyte is much higher than those of sulfide electrolytes and halide electrolytes). By developing a fluoride-containing electrolyte material, all-solid-state batteries of 6 V or higher can be achieved, which are compatible with more cathode materials with the high energy density.

### BRIEF DESCRIPTION OF DRAWINGS

To describe the technical solution in examples of the present disclosure more clearly, the accompanying drawings required for describing the examples or the prior art will be briefly introduced below. Apparently, the accompanying drawings in the following description show merely some examples of the present disclosure, and those of ordinary skill in the art can still derive other accompanying drawings from these accompanying drawings without creative efforts.

FIG. 1 is an electrochemical impedance spectroscopy of (Li₃PO₄)TiF₄ synthesized in Example 1;

FIG. 2 shows X-ray diffraction pattern of a halogen-boron fluorine solid-state electrolyte (LiBF₄)₂TaCl₅, a halogen-boron fluorine solid-state electrolyte (LiBF₄)₃TaCl₅, and a halogen-boron fluorine solid-state electrolyte (LiBF₄)TaCl₅ that are synthesized in Examples 6-8 respectively. In the figure, the abscissa denotes a diffraction angle (2 Theta) in degrees (°), and the ordinate denotes diffraction intensity;

FIG. 3 is an X-ray diffraction pattern of a solid-state electrolyte (Li₃PO₄)TiF₄ synthesized in Example 1. In the figure, the abscissa denotes a diffraction angle (2 Theta) in degrees (°), and the ordinate denotes diffraction intensity;

FIG. 4 shows a linear sweep curve of a solid-state electrolyte (LiBF₄)₂TaCl₅ according to Example 6 of the present disclosure, and a linear sweep curve of a solid-state electrolyte Li₂ZrCl₆ according to Comparative Example 3. The abscissa denotes a voltage in volts (V), and the ordinate denotes current density in milliamps per gram (mA g⁻¹);

FIG. 5 shows a linear sweep curve of a solid-state electrolyte (Li₃PO₄)TiF₄ synthesized in Example 1 of the present disclosure, and a linear sweep curve of a solid-state electrolyte Li₂ZrCl₆ according to Comparative Example 3. The abscissa denotes a voltage in volts (V), and the ordinate denotes current density in milliamps per gram (mA g⁻¹);

FIG. 6 is a charge-discharge curve of an all-solid-state lithium battery assembled in Example 8 of the present disclosure in the first three cycles at a rate of 0.3 C. In the figure, the abscissa denotes a specific capacity in milliampere hour per gram (mAh g⁻¹), and the ordinate denotes a voltage in volts (V) relative to Li⁺/Li; and

FIG. 7 is a charge-discharge curve of an all-solid-state lithium battery assembled in Example 9 of the present disclosure in the first three cycles at a rate of 0.3 C. In the figure, the abscissa denotes a specific capacity in milliampere hour per gram (mAh g⁻¹), and the ordinate denotes a voltage in volts (V) relative to Li⁺/Li.

### DETAILED DESCRIPTION OF THE EMBODIMENTS

To make the technical problems to be solved, technical solutions, and beneficial effects of the present disclosure clearer, the present disclosure is further described in detail with reference to examples. It should be understood that specific examples described herein are merely used to explain the present disclosure, and are not intended to limit the present disclosure.

In the present disclosure, the term “and/or” describing an association relation of associated objects, indicates that three relations can exist. For example, A and/or B can indicate: A exists alone, both A and B exist, and B exists alone. A and B can be singular or plural. The character “/” generally indicates an “or” relation between the associated objects.

In the present disclosure, “at least one” indicates one or more, and “a plurality of” indicates two or more. “At least one of the following”, etc. indicate any combination of these items, including a single one or any combination of plural ones. For example, “at least one of a, b, or c” or “at least one of a, b, and C” can indicate a, b, c, a-b (i.e. a and b), a-c, b-c, or a-b-c, where a, b, and c can be singular or plural.

It should be understood that in all the examples of the present disclosure, the serial numbers of all processes described above do not indicate execution orders, and some or all steps can be executed in parallel or in sequence. The execution order of each process should be determined by its function and internal logic, and should not limit implementation processes in the examples of the present disclosure in any way.

The terms used in the examples of the present disclosure are merely to describe particular examples, instead of limiting the present disclosure. The singular forms “a”, “an”, “the”, and “this” used in the examples and the appended claims of the present disclosure are also intended to include the plural forms, unless clearly stated in the context otherwise.

The weight of a relevant component mentioned in the example description of the present disclosure can not only indicate the specific content of each component, but can also indicate a weight ratio relation between the components. Thus, the proportional increase or decrease in the content of the relevant component according to the example description of the present disclosure falls within the scope disclosed in the example description of the present disclosure. Specifically, the mass in the example description of the present disclosure can be in a mass unit commonly known in the field of chemical industry, such as ug, mg, g, and kg.

In a first aspect, a fluorine-containing solid-state electrolyte is provided in the examples of the present disclosure. The fluorine-containing solid-state electrolyte has a general structural formula (AX)ₐMB_{y}, where A denotes at least one of Li, Na, K, Ag, and Cu, M denotes at least one of Ti, Sn, Ta, Nb, Zr, Hf, Ga, Al, and Fc, and 0.5<a<4;

B denotes F, X denotes at least one of an oxygen-containing anion and a fluorine-containing anion, y equals 4 or 5; or B denotes at least one of F, Cl, Br, and I, X denotes BF₄, and y equals 3, 4, or 5.

The fluorine-containing solid-state electrolyte according to the example of the present disclosure mainly has two types.

The first type of fluorine-containing solid-state electrolyte has a general structural formula (AX)ₐMF_{y}, where A denotes at least one of Li, Na, K, Ag, and Cu, M denotes at least one of Ti, Sn, Ta, Nb, Zr, Hf, Ga, Al, and Fe, X denotes at least one of an oxygen-containing anion and a fluorine-containing anion, 0.5<a<4, and y equals 4 or 5. Such a fluorine-containing solid-state electrolyte may be named a perfluorinated solid-state electrolyte.

The second type of fluorine-containing solid-state electrolyte has a general structural formula (ABF₄)ₐMB_{y}, where A denotes at least one of Li, Na, K, Ag, and Cu, M denotes at least one of Ti, Sn, Ta, Nb, Zr, Hf, Ga, Al, and Fe, B denotes at least one of F, Cl, Br, and I, 0.5<a<4, and y equals 3, 4, or 5. Such a fluorine-containing solid-state electrolyte may be named a halogen-boron fluorine solid-state electrolyte. In the formula, “B” in “BF₄” denotes a boron element, and “B” in “MB_{y}” denotes at least one of F, Cl, Br, and I.

X denotes at least one of an oxygen-containing anion and a fluorine-containing anion; and may be one or more of oxygen-containing anions, or one or more of fluorine-containing anion groups, or a combination of one or more of oxygen-containing anions and one or more of fluorine-containing anions.

In the examples of the present application, X denotes the anion, and MB_{y} denotes a transition metal-halogen ion polyhedron.

In the examples of the present disclosure, the X anions are connected to the transition metal-halogen ion polyhedra, so as to an open frame structure, a crosslinked net-shaped framework and a penetrated-through three-dimensional channel are established, and vacancies are filled with A ions. Through such a design, the A ions can be rapidly conducted in a structure large free volume. The solid-state electrolyte, according to the examples of the present disclosure, has the high ionic conductivity.

Fluorine ions have the high electronegativity (for example, the oxidation potential limit of a perfluorinated electrolyte is much higher than those of sulfide electrolytes and halide electrolytes). By developing a fluoride-containing electrolyte material, all-solid-state batteries of 6 V or higher can be achieved, which are compatible with more cathode materials with the high energy density.

In some examples, the general structural formula is (AX)ₐMB_{y}, where A denotes Li, M denotes at least one of Zr, Hf, Ta, Nb, Al, Fe, and Ga, B denotes at least one of F, Cl, Br, and I, X denotes BF₄, y equals 3 or 4, and 0.5<a<4.

In the examples of the present disclosure, the general structural formula is (AX)ₐMF_{y}, and such an electrolyte may be named a perfluorinated solid-state electrolyte.

In some examples, the general structural formula is (AX)ₐMB_{y}, where A denotes at least one of Li, Na, K, Ag, and Cu, M denotes at least one of Ti, Sn, Ta, Nb, Zr, Hf, and Ga, B denotes F, X denotes at least one of an oxygen-containing anion and a fluorine-containing anion, y equals 4 or 5, and 0.5<a<4.

In the examples of the present disclosure, the general structural formula is (AX)ₐMB_{y}, such an electrolyte may be named a halogen-boron fluorine solid-state electrolyte.

In some examples, the oxygen-containing anion includes at least one of O, O₂, CO₃, PO₄, SO₄, SiO₃, SiO₄, NO₃, MoO₃, WO₃, B₄O₇, and P₂O₇; and/or the fluorine-containing anion includes at least one of BF₄, PF₆, and AsF₆.

In some examples, X anions in the fluorine-containing solid-state electrolyte are connected to transition metal-halogen ion polyhedra, so as to form an open frame structure, and vacancies of an open frame are filled with A ions.

For the first type of fluorine-containing solid-state electrolyte (AX)ₐMF_{y}, according to a material system, the X anions are connected to fluorinated transition metal polyhedra (MF_{y}), so as to form an open frame structure, and vacancies of an open frame are filled with A ions. Thus, a particular glass-ceramic phase is obtained, the ions are rapidly conducted, and the ionic conductivity is greater than 0.1 mS/cm at 60° C. The glass phase and a glass-ceramic interface take main roles in rapid ion conduction in a particular glass-ceramic phase structure.

For the second type of fluorine-containing solid-state electrolyte (ABF₄)ₐMB_{y}, according to a material system, BF₄ tetrahedra are connected to transition metal-halogen ion polyhedra MB_{y}, so as to form an open frame structure, and vacancies of an open frame are filled with halogen ions (such as Li), so that a particular glass-ceramic phase is obtained. Thus, the ions are rapidly conducted, and the ionic conductivity at room temperature is greater than 0.1 mS/cm. The glass phase and a glass-ceramic interface take main roles in rapid ion conduction in a particular glass-ceramic phase structure.

In some examples, the fluorine-containing solid-state electrolyte further includes an auxiliary additive, where the mass of the auxiliary additive satisfies 0<w %≤20%.

To further improve the electrochemical performance of the fluorine-containing solid-state electrolyte, the additive with a particular component may be added to the glass phase and the ceramic phase through compounding, chemical combination, solid solution, or mixing. The additive may further include one or a combination of more of H, C, N, O, Si, P, S, Se, In, Ge, Sn, etc. The additive may alternatively include one or a combination of more of an alkali metal element, an alkaline earth metal element, a transition metal element, and a rare earth element.

In a second aspect, a preparation method for a fluorine-containing solid-state electrolyte is provided in the examples of the present disclosure. The preparation method includes: a solid-phase reaction is performed on AX powder and MB_{y} powder at a stoichiometric ratio through a mechanical ball milling method under an inert atmosphere without water and oxygen, so as to obtain a fluorine-containing solid-state electrolyte (AX)ₐMB_{y}.

In some examples, the inert atmosphere without water and oxygen indicates N₂ or Ar.

Further, Ar is used as the inert atmosphere.

In some examples, in a process of mechanical ball milling, it is necessary to effectively cool a ball milling pot, so as to avoid excessive temperature of the pot. Further, a circulating water cooling method is employed.

In some examples, for the first type of fluorine-containing solid-state electrolyte (AX)ₐMF_{y}, a solid-phase reaction is performed on AX powder and MF_{y} powder at a stoichiometric ratio through the mechanical ball milling method under an inert atmosphere without water and oxygen, so as to obtain a perfluorinated solid-state electrolyte (AX)ₐMF_{y}.

In some examples, for the second type of fluorine-containing solid-state electrolyte (ABF₄)ₐMB_{y}, a solid-phase reaction is performed on raw materials ABF₄ powder and MB_{y} powder at a stoichiometric ratio through the mechanical ball milling method under the inert atmosphere without water and oxygen, so as to obtain a halogen-boron fluorine solid-state electrolyte (ABF₄)ₐMB_{y}.

In some examples in a treatment process of the mechanical ball milling method, parameters are controlled to satisfy the following (1)-(4):
(1) a diameter of ball milling balls is 3 mm to 10 mm;
(2) a material-to-ball ratio is 60:1 to 20:1;
(3) ball milling time is 1 h to 30 h; and
(4) a rotation speed of a ball mill is 400 r/min to 800 r/min.

Further, the diameter of the ball milling balls is 3 mm to 10 mm. In specific instances, the diameter of the ball milling balls is 3 mm, 4 mm, 5 mm, 6 mm, 7 mm, 8 mm, 9 mm, 10 mm, etc.

Further, the material-to-ball ratio is 60:1 to 20:1. In specific instances, the material-to-ball ratio is 20:1, 25:1, 30:1, 35:1, 40:1, 45:1, 50:1, 55:1, 60:1, etc.

Further, the ball milling time is 1 h to 30 h. In specific instances, the ball milling time is 1 h, 1.5 h, 2 h, 3 h, 5 h, 6 h, 8 h, 10 h, 12 h, 14 h, 18 h, 20 h, 22 h, 24 h, 26 h, 28 h, 30 h, etc.

Further, the rotation speed of the ball mill is 400 r/min to 800 r/min. In specific instances, the rotation speed of the ball mill is 400 r/min, 450 r/min, 500 r/min, 550 r/min, 600 r/min, 650 r/min, 700 r/min, 750 r/min, 800 r/min, etc.

Further, the diameter of the ball milling balls is 3 mm, and the material-to-ball ratio is 30:1. Further, the ball milling time is 6 h, and the rotation speed of the ball mill is 500 r/min.

It should be noted that in the present disclosure, when mild ball milling conditions are used (for example, the diameter of the ball milling balls is 3 mm, the material-to-ball ratio is 20:1, the ball milling time is 1 h, and the rotation speed of the ball mill is 400 r/min), the energy provided through ball milling is insufficient to drive the reaction to be conducted, and thus a large number of raw materials remain in a final product. When intense ball milling conditions are used (for example, the diameter of the ball milling balls is 10 mm, the material-to-ball ratio is 80:1, the ball milling time is 40 h, the rotation speed of the ball mill is 800 r/min), thermodynamically-stable impurity phases, including LiCl, LiF, etc., are precipitated through excessive ball milling. Thus, specific parameters of the treatment through the mechanical ball milling method are defined in the present disclosure after sufficient research. The particular ball milling conditions are required to obtain an impurity-free electrolyte with the high ionic conductivity. As a preferred solution, the ball milling conditions may be set as follows: the diameter of the ball milling balls is 3 mm, the material-to-ball ratio is 60:1, and the rotation speed of the ball mill is 600 r/min. Thus, it is fully ensured that the impurity-free electrolyte with the high ionic conductivity is obtained.

In some examples, before the treatment through the mechanical ball milling method, the preparation method further includes: a pre-mixing treatment, where the pre-mixing treatment includes: the AX powder and the MB_{y} powder are pre-mixed at the stoichiometric ratio in the inert atmosphere without water and oxygen, so as to obtain pre-mixed powder; and then the pre-mixed powder is synthesized into the fluorine-containing solid-state electrolyte (AX)ₐMB_{y} through the mechanical ball milling method.

Further, the inert atmosphere without water and oxygen indicates N₂ or Ar. Furthermore, Ar is used as the inert atmosphere.

Further, pre-mixing may be performed through manual milling with a mortar, mixing with a mixer, etc.

In a third aspect, a battery is provided in the examples of the present disclosure. The battery includes the above fluorine-containing solid-state electrolyte or the fluorine-containing solid-state electrolyte obtained through the above preparation method.

In some examples, the battery is an all-solid-state battery.

Further, the all-solid-state battery includes a cathode, an anode, and a solid-state electrolyte sheet positioned between the cathode and the anode. The solid-state electrolyte sheet is obtained by cold-pressing a solid electrolyte material. The solid-state electrolyte material includes the above fluorine-containing solid-state electrolyte or the fluorine-containing solid-state electrolyte prepared through the above preparation method.

Further, the cathode is obtained by performing cold-pressing or coating on a cathode active material and cathode filler.

The cathode active material includes, but is not limited to, at least one of cobalt-aluminum oxide, lithium iron phosphate, lithium-rich phase lithium-manganese oxide, lithiated layered oxide, and lithiated layered sulfide. The cathode filler is at least one of an ion conduction agent, a conductive agent, and an adhesive. A solid-state electrolyte between the ion conduction agent and a cathode of the battery, and a solid-state electrolyte between the ion conduction agent and an anode of the battery are identical materials. The conductive agent may include at least one of graphite, carbon black, acetylene black, ketjen black, and carbon fibers. The adhesive may include at least one of styrene butadiene rubber, polytetrafluoroethylene, polyvinylidene fluoride, and polyethylene, for example. It is common practice to prepare the cathode through cold-pressing or coating in the art.

Further, the anode is obtained by performing cold-pressing or coating on an anode active material and anode filler.

The anode active material indicates a material capable of storing and releasing A+ ions, including, but not limited to, a metal material, graphite, silicon, etc. The metal material may be an elementary-substance metal or alloy. No anode filler is used when the metal material is used as the anode active material. The anode filler is at least one of an ion conduction agent, a conductive agent, and an adhesive. A solid-state electrolyte between the ion conduction agent and the cathode of the battery, and a solid-state electrolyte between the ion conduction agent and the anode of the battery are identical materials. The conductive agent may include at least one of graphite, carbon black, acetylene black, ketjen black, and carbon fibers. The adhesive may include at least one of styrene butadiene rubber, polytetrafluoroethylene, polyvinylidene fluoride, and polyethylene, for example. It is common practice to prepare the anode through the cold-pressing or coating in the art.

The present disclosure is described below with reference to the specific examples.

### Example 1

A perfluorinated solid-state electrolyte (Li₃PO₄)TiF₄ is provided in the example. A specific preparation method is described as follows:

Li₃PO₄ and TiF₄ were mixed at a molar ratio of 1:1 in an argon-filled glove box with O₂ and H₂O levels below 0.1 ppm, and manually milled with an agate mortar for 10 min, so as to be fully pre-mixed.

Pre-mixed powder (1 g or so) was transferred to a 75 mL ball mill pot, and 40 g of milling balls with a diameter of 3 mm were correspondingly added. Then, the ball mill pot was vacuumized and sealed. Ball milling was performed by a planetary ball mill at a rotation speed of 600 r/min for 6 h. After ball milling was completed, the ball milling pot was transferred into the glove box, and opened, and powder in the pot was taken out, which was a synthesized perfluorinated solid-state electrolyte (Li₃PO₄)TiF₄.

### Example 2

A perfluorinated solid-state electrolyte (Li₃PO₄)SnF₄ is provided in the example. A specific preparation method is identical to that in Example 1 except that a raw material TiF₄ was replaced with SnF₄.

### Example 3

A perfluorinated solid-state electrolyte (Li₂CO₃)TiF₄ is provided in the example. A specific preparation method is identical to that in Example 1 except that a raw material Li₃PO₄ was replaced with Li₂CO₃.

### Example 4

A perfluorinated solid-state electrolyte (LiBF₄)₂TiF₄ is provided in the example. A specific preparation method is identical to that in Example 1 except that

a raw material Li₃PO₄ was replaced with LiBF₄, and a corresponding molar ratio of the raw materials was changed from 1:1 to 2:1.

### Example 5

A perfluorinated solid-state electrolyte (Li₃PO₄)(SiF₄)_{0.2}TiF₄ is provided in the example. A specific preparation method is identical to that in Example 1 except that

a raw material SiF₄ was added, and a molar ratio of the raw materials was changed to Li₃PO₄:SiF₄:TiF₄=1:0.2:1.

### Example 6

A halogen-boron fluorine solid-state electrolyte (LiBF₄)₂TaCl₅ is provided in the example. A specific preparation method is described as follows:

LiBF₄ and TaCl₅ were mixed at a molar ratio of 2:1 in an argon-filled glove box with O₂ and H₂O levels below 0.1 ppm, and manually milled with the agate mortar for 10 min, so as to be fully pre-mixed.

Pre-mixed powder (1 g or so) was transferred to the 75 mL ball mill pot, and 40 g of milling balls with a diameter of 3 mm were correspondingly added. Then, the ball mill pot was vacuumized and sealed. Ball milling was performed by the planetary ball mill at a rotation speed of 600 r/min for 10 h. After ball milling was completed, the ball milling pot was transferred into the glove box and opened, and powder in the pot was taken out, which was a synthesized halogen-boron fluorine solid-state electrolyte (LiBF₄)₂TaCl₅.

### Example 7

A halogen-boron fluorine solid-state electrolyte (LiBF₄)₃TaCl₅ is provided in the example. A specific preparation method is identical to that in Example 1 except that a molar ratio of LiBF₄ to TaCl₅ was changed from 2:1 to 3:1.

### Example 8

A halogen-boron fluorine solid-state electrolyte (LiBF₄) TaCl₅ is provided in the example. A specific preparation method is identical to that in Example 1 except that a molar ratio of LiBF₄ to TaCl₅ was changed from 2:1 to 1:1.

### Example 9

A halogen-boron fluorine solid-state electrolyte (LiBF₄)₂ZrCl₄ is provided in the example.

A specific preparation method is identical to that in Example 1 except that a raw material TaCl₅ was replaced with ZrCl₄, and ball milling time was changed from 10 h to 20 h.

### Example 10

A halogen-boron fluorine solid-state electrolyte (Li₂O)_{0.2}(LiBF₄)₂TaCl₅ is provided in the example. A specific preparation method is identical to that in Example 1 except that

an additive Li₂O was added to raw materials, and a molar ratio of the raw materials was changed to Li₂O:LiBF₄:TaCl₅=0.2:2:1.

### Example 11

An all-solid-state lithium battery is provided in the example. The all-solid-state lithium battery is obtained by assembling the perfluorinated solid-state electrolyte (Li₃PO₄)TiF₄ according to Example 1. A specific assembly process is described as follows:

Step 1: a lithium-rich cathode Li_{1.14}Ni_{0.29}Mn_{0.57}O₂ (as a cathode active material), (Li₃PO₄)TiF₄ (as an ion conduction agent), and vapor grown carbon fibers (VGCFs, as an electron conduction agent) that were commercially available were weighed at a mass ratio of 65:30:5, and manually milled in the mortar for 10 min, so as to be uniformly mixed, and thus a composite cathode was formed.

Step 2: 50 mg of the perfluorinated solid-state electrolyte (Li₃PO₄)TiF₄ powder synthesized in Example 1 was weighed, and cold-pressed into a solid-state electrolyte sheet with a diameter of 10 mm at a pressure of 100 MPa, and the pressure was maintained for 2 min. Next, 50 mg of Li₆PS₅Cl was weighed as a barrier layer between the perfluorinated solid-state electrolyte (Li₃PO₄)TiF₄ and a LiIn anode, and evenly spread on a surface on one side of a (Li₃PO₄)TiF₄ solid-state electrolyte sheet. A resulting electrolyte sheet was cold-pressed at the pressure of 100 MPa, and the pressure was maintained for 2 min.

Step 3: 10 mg of the composite cathode prepared in step 1 was weighed, and evenly spread on a surface on the other side of the (Li₃PO₄)TiF₄ solid-state electrolyte sheet prepared in step 2. A resulting solid-state electrolyte sheet was cold-pressed at a pressure of 350 MPa, and the pressure was maintained for 2 min.

Step 4: a commercially-available indium sheet (with a diameter of 10 mm and a thickness of 200 μm) was taken as an anode active material, and attached to a surface on the other side of a Li₆PS₅Cl barrier layer prepared in step 2, so as to form a four-layer structure of “cathode-solid-state electrolyte sheet-barrier layer-anode”. The pressure of 100 MPa was applied to an entire structure, and the all-solid-state lithium battery was obtained after assembly was completed.

The above steps 1-4 were performed in the argon-filled glove box with O₂ and H₂O levels below 0.1 ppm.

### Example 12

An all-solid-state lithium battery is provided in the example. The all-solid-state lithium battery is obtained by assembling the halogen-boron fluorine solid-state electrolyte (LiBF₄)₂TaCl₅ according to Example 1. A specific assembly process is described as follows:

Step 1: a lithium-rich cathode Li_{1.14}Ni_{0.29}Mn_{0.57}O₂ (as a active material), (LiBF₄)₂TaCl₅ (as an ion conduction agent), and vapor grown carbon fibers (VGCFs, as an electron conduction agent) that were commercially available were weighed at a mass ratio of 65:30:5, and manually milled in the mortar for 10 min, so as to be uniformly mixed, and thus a composite cathode was formed.

Step 2: 50 mg of the halogen-boron fluorine solid-state electrolytes (LiBF₄)₂TaCl₅ powder synthesized in Example 1 was weighed, and cold-pressed into a solid-state electrolyte sheet with a diameter of 10 mm at a pressure of 100 MPa, and the pressure was maintained for 2 min. Next, 50 mg of Li₆PS₅Cl was weighed as a barrier layer between the halogen-boron fluorine solid-state electrolyte (LiBF₄)₂TaCl₅ and a LiIn anode, and evenly spread on a surface on one side of a (LiBF₄)₂TaCl₅ solid-state electrolyte sheet. A resulting electrolyte sheet was cold-pressed at the pressure of 100 MPa, and the pressure was maintained for 2 min.

Step 3: 10 mg of the composite cathode prepared in step 1 was weighed, and evenly spread on a surface on the other side of the (LiBF₄)₂TaCl₅ solid-state electrolyte sheet prepared in step 2. A resulting solid-state electrolyte sheet was cold-pressed at a pressure of 350 MPa, and the pressure was maintained for 2 min.

Step 4: a commercially-available indium sheet (with a diameter of 10 mm and a thickness of 200 μm) was taken as an anode active material, and attached to a surface on the other side of a Li₆PS₅Cl barrier layer prepared in step 2, so as to form a four-layer structure of “cathode-solid-state electrolyte sheet-barrier layer-anode”. The pressure of 100 MPa was applied to an entire structure, and the all-solid-state lithium battery was obtained after assembly was completed.

The above steps 1-4 were performed in the argon-filled glove box with O₂ and H₂O levels below 0.1 ppm.

### Example 13

An all-solid-state LiIn—LiCoO₂ battery is provided in the example. A specific assembly process is identical to that in Example 12 except that

a cathode active material was changed from Li_{1.14}Ni_{0.29}Mn_{0.57}O₂ to LiCoO₂, a conductive agent was changed from VGCF to carbon black, and a corresponding mass ratio of raw materials was changed from 65:30:5 to 70:30:1.

### Comparative Example 1

A solid-state electrolyte is provided in the case. A specific preparation method is described as follows:

LiF and TaF₅ were mixed at a molar ratio of 1:1 in the argon-filled glove box with O₂ and H₂O levels below 0.1 ppm, and manually milled with the agate mortar for 10 min, so as to be fully mixed.

Mixed powder (1 g or so) was transferred to the 75 mL ball mill pot, and 40 g of milling balls with a diameter of 3 mm were correspondingly added. Then, the ball mill pot was vacuumized and sealed. Ball milling was performed by the planetary ball mill at a rotation speed of 600 r/min for 20 h. After ball milling was completed, the ball milling pot was transferred into the glove box, and opened, and powder in the pot was taken out, which was a synthesized LiTaF₆ halide solid-state electrolyte.

### Comparative Example 2

A solid-state electrolyte is provided in the case. A specific preparation method is described as follows:

LiF and ZrCl₄ were mixed at a molar ratio of 8:1 in the argon-filled glove box with O₂ and H₂O levels below 0.1 ppm, and manually milled with the agate mortar for 10 min, so as to be fully pre-mixed.

Pre-mixed powder (1 g or so) was transferred to the 75 mL ball mill pot, and 40 g of milling balls with a diameter of 3 mm were correspondingly added. Then, the ball mill pot was vacuumized and sealed. Ball milling was performed by the planetary ball mill at a rotation speed of 600 r/min for 20 h. After ball milling was completed, the ball milling pot was transferred into the glove box, and opened, and powder in the pot was taken out, which was a synthesized Li₈F₈ZrCl₄ halide solid-state electrolyte.

### Comparative Example 3

A solid-state electrolyte is provided in the case. A specific preparation method is described as follows:

LiCl and ZrCl₄ were mixed at a molar ratio of 2:1 in an argon-filled glove box with O₂ and H₂O levels below 0.1 ppm, and manually milled with the agate mortar for 10 min, so as to be fully pre-mixed.

Pre-mixed powder (1 g or so) was transferred to the 75 mL ball mill pot, and 40 g of milling balls with a diameter of 3 mm were correspondingly added. Then, the ball mill pot was vacuumized and sealed. Ball milling was performed by the planetary ball mill at a rotation speed of 600 r/min for 20 h. After ball milling was completed, the ball milling pot was transferred into the glove box, and opened, and powder in the pot was taken out, which was a synthesized Li₂ZrCl₆ halide solid-state electrolyte.

### I. Characterization Analysis

### 1. Ionic Conductivity Characterization Analysis

### (1) Characterization Method

The solid-state electrolyte powder prepared in Examples 1-4, Examples 6-10, and Comparative Examples 1-2 was filled into cylindrical sheet pressing molds (with a diameter of 10 mm) in the argon-filled glove box with O₂ and H₂O levels below 0.1 ppm. The molds were cold-pressed at the pressure of 375 MPa for 2 min, so as to obtain solid-state electrolyte sheets with a thickness of 0.5 mm to 1.5 mm and a diameter of 10 mm. An upper surface and a lower surface of the solid-state electrolyte sheet were plated with gold, then clamped with two stainless steel blocking electrodes, and finally connected to an electrochemical workstation. An electrochemical impedance spectroscopy was tested at room temperature. Li⁺ ion conductivity at the room temperature was extracted from the tested electrochemical impedance spectroscopy.

### (2) Characterization Result

Table 1 shows the ionic conductivity of each solid-state electrolyte sample at 60°.

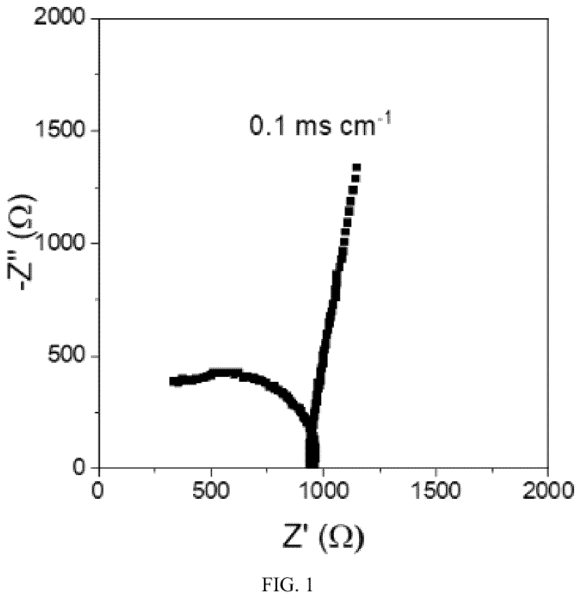

FIG. 1 shows an electrochemical impedance spectroscopy of (Li₃PO₄)TiF₄ synthesized in Example 1 at 60°.

TABLE 1
Ionic Conductivities of Solid-state Electrolyte Samples

| Sample | Ionic Conductivity S cm⁻¹ |
|---|---|
| (Li₃PO₄)TiF₄ (Example 1) | 0.1 × 10⁻³ |
| (Li₃PO₄)SnF₄ (Example 2) | 0.05 × 10⁻³ |
| (Li₂CO₃)TiF₄ (Example 3) | 0.1 × 10⁻³ |
| (LiBF₄)₂TiF₄ (Example 4) | 0.02 × 10⁻³ |
| LiTaF₆ (Comparative Example 1) | 0.004 × 10⁻³ |
| (LiBF₄)₂TaCl₅ (Example 6) | 0.74 × 10⁻³ |
| (LiBF₄)₃TaCl₅ (Example 7) | 0.21 × 10⁻³ |
| (LiBF₄)TaCl₅ (Example 8) | 0.53 × 10⁻³ |
| (LiBF₄)₂ZrCl₄ (Example 9) | 0.12 × 10⁻³ |
| (Li₂O)_{0.2}(LiBF₄)₂TaCl₅ (Example 10) | 1.34 × 10⁻³ |
| Li₈F₈ZrCl₄ (Comparative Example 2) | 0.01 × 10⁻³ |

### 2. Crystal Structure Characterization Analysis

### (1) Characterization Method

The solid-state electrolytes prepared in Examples 6-8 were characterized through an X-ray diffractometer.

### (2) Characterization Result

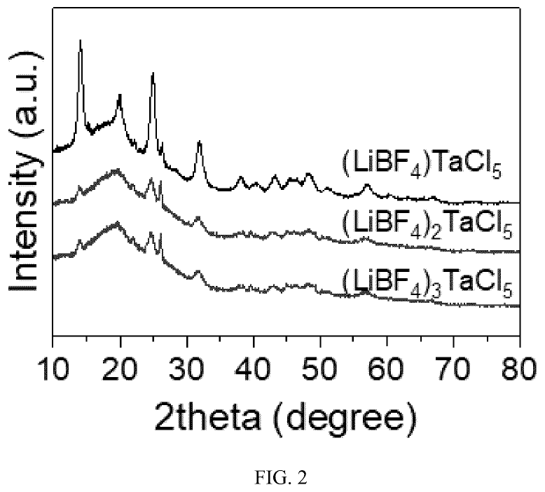

As shown in FIG. 2, crystal structures of the solid-state electrolyte (LiBF₄)₂TaCl₅, the solid-state electrolyte (LiBF₄)₃TaCl₅, the solid-state electrolyte (LiBF₄)TaCl₅, and the solid-state electrolyte (Li₃PO₄)TiF₄ synthesized in the examples are characterized respectively.

The results show that diffraction peaks of three halogen-boron fluorine solid-state electrolytes provided in the examples may be calibrated as residual raw-material phases LiBF₄, and characteristic X-ray diffraction (XRD) peaks are located at 2 theta=14.1°, 20.0°, 24.9°, 26.4°, and 31.8°. It is shown that a large number of amorphous phases exist in the three halogen-boron fluorine solid-state electrolytes, in addition to raw-material crystalline phases, and the amorphous phases encompass Li, B, F, Ta, and Cl.

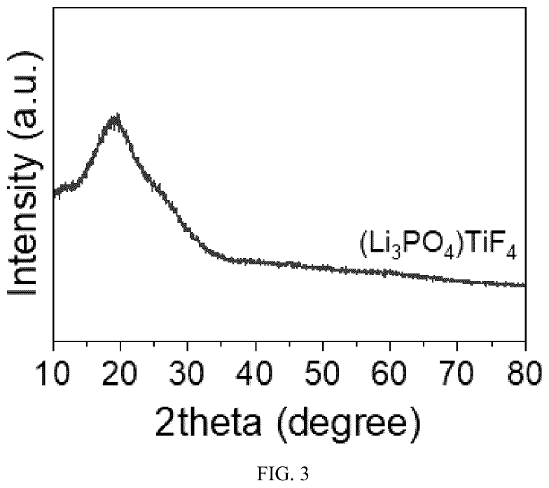

An XRD pattern of (Li₃PO₄)TiF₄ is shown in FIG. 3. No characteristic diffraction peak appears. The solid-state electrolyte (Li₃PO₄)TiF₄ is amorphous.

### 3. Electrochemical Window Test

### (1) Test Method

A battery configured as solid-state electrolyte+carbon black (at a mass ratio of 5:5)|solid-state electrolyte|Li₆PS₅Cl|Li was tested by an EC-lab electrochemical workstation at room temperature through a linear sweep method.

### (2) Test Result

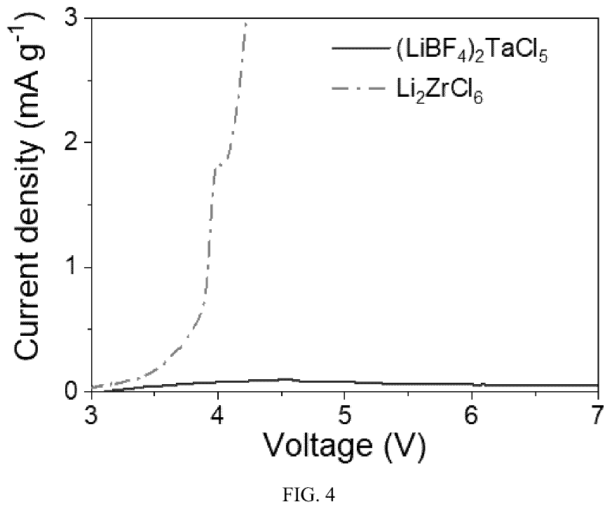

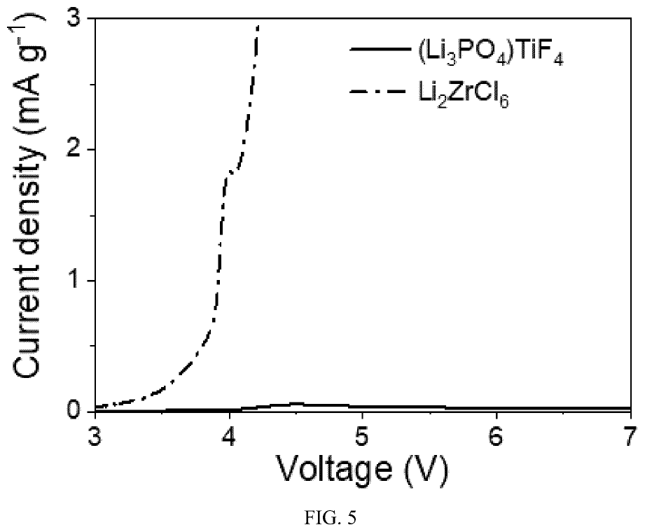

The test results are shown in FIGS. 4 and 5. (LiBF₄)₂TaCl₅ still has no obvious oxidation peak at 6 V or higher. (Li₃PO₄)TiF₄ has no obvious oxidation peak at 6 V or higher.

### 4. Galvanostatic Charge-Discharge Test

### (1) Test Method

The all-solid-state batteries according to Examples 9-10 undergone the galvanostatic charge-discharge test through a LAND battery test system at room temperature, where a voltage range was 2.5 V to 4.8 V (a voltage relative to Li⁺/Li), and a circulating rate was 0.3 C.

### (2) Test Result

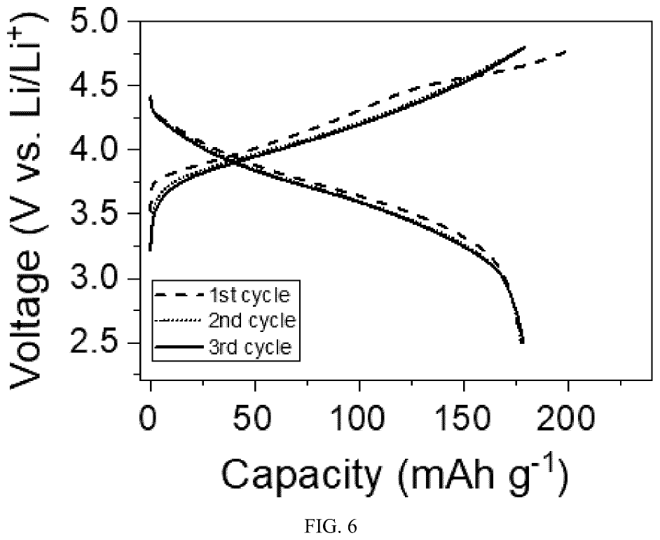

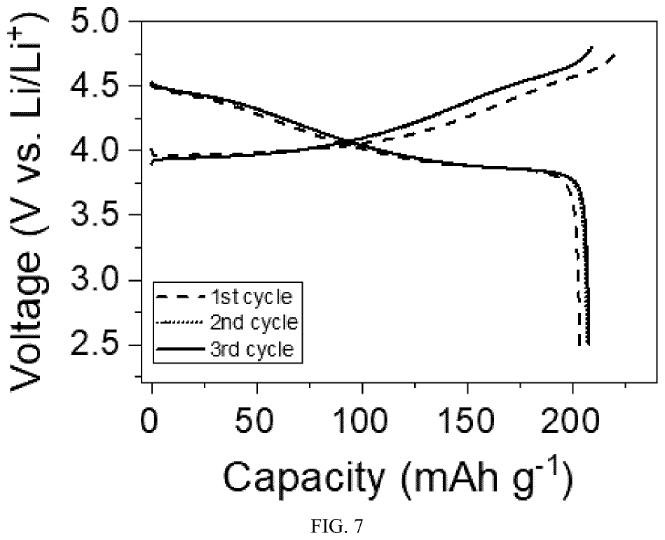

The test results are shown in FIGS. 6 and 7.

The all-solid-state battery according to Example 9 has a reversible capacity of 177.2 mAh g⁻¹ at the rate of 0.3 C, the initial Coulombic efficiency of 87.0%, and the secondary Coulombic efficiency of 99.3%.

The all-solid-state battery according to Example 10 has a reversible capacity of 203.1 mAh g⁻¹ at the rate of 0.3 C, the initial Coulombic efficiency of 91.5%, and the secondary Coulombic efficiency of 99.2%.

What is described above are merely preferred examples of the present disclosure, and are not intended to limit the present disclosure. Any modifications, equivalent replacements, improvements, etc. made within the spirit and principles of the present disclosure should fall within the scope of protection of the present disclosure.

What is claimed is:

1. A fluorine-containing solid-state electrolyte, having a general structural formula (AX)ₐMB_{y}, wherein A denotes at least one of Li, Na, K, Ag, and Cu, M denotes at least one of Ti, Sn, Ta, Nb, Zr, Hf, Ga, Al, and Fe, and 0.5<a<4;
B denotes F, X denotes at least one of an oxygen-containing anion and a fluorine-containing anion, and y equals 4 or 5; or
B denotes at least one of F, Cl, Br, and I, X denotes BF₄, and y equals 3, 4, or 5.

2. The fluorine-containing solid-state electrolyte according to claim 1, wherein
A denotes Li;
M denotes at least one of Zr, Hf, Ta, Nb, Al, Fe, and Ga;
B denotes at least one of F, Cl, Br, and I;
X denotes BF₄; and
y equals 3 or 4.

3. The fluorine-containing solid-state electrolyte according to claim 1, wherein
A denotes at least one of Li, Na, K, Ag, and Cu;
M denotes at least one of Ti, Sn, Ta, Nb, Zr, Hf, and Ga;
B denotes F, and X denotes at least one of the oxygen-containing anion and the fluorine-containing anion; and
y equals 4 or 5.

4. The fluorine-containing solid-state electrolyte according to claim 1, wherein a source of the oxygen-containing anion comprises at least one of O, O₂, CO₃, PO₄, SO₄, SiO₃, SiO₄, NO₃, MoO₃, WO₃, B₄O₇, and P₂O₇; and/or a source of the fluorine-containing anion comprises at least one of BF₄, PF₆, and AsF₆.

5. The fluorine-containing solid-state electrolyte according to claim 1, wherein X in the fluorine-containing solid-state electrolyte is connected to a transition metal-halogen ion polyhedron composed of MB_{y} in (AX)ₐMB_{y}, so as to form an open frame structure, and vacancies of an open frame structure are filled with A ions.

6. The fluorine-containing solid-state electrolyte according to claim 1, further comprising an auxiliary additive, wherein the mass of the auxiliary additive satisfies 0<w %≤20%.

7. A preparation method for a fluorine-containing solid-state electrolyte, comprising:
performing a solid-phase reaction on AX powder and MB_{y} powder at a stoichiometric ratio through a mechanical ball milling method under an inert atmosphere without water and oxygen, so as to obtain a fluorine-containing solid-state electrolyte (AX)ₐMB_{y}.

8. The preparation method for a fluorine-containing solid-state electrolyte according to claim 7, wherein
in a treatment process of the mechanical ball milling method, parameters are controlled to satisfy the following (1)-(4):
(1) a diameter of ball milling balls is 3 mm to 10 mm;
(2) a material-to-ball ratio is 60:1 to 20:1;
(3) ball milling time is 1 h to 30 h; and
(4) a rotation speed of a ball mill is 400 r/min to 800 r/min.

9. The preparation method for a fluorine-containing solid-state electrolyte according to claim 7, wherein
before a treatment through the mechanical ball milling method, the preparation method further comprises a pre-mixing treatment, wherein the pre-mixing treatment comprises:
pre-mixing the AX powder and the MB_{y} powder at the stoichiometric ratio in an argon-filled glove box with O₂ and H₂O levels below 0.1 ppm, so as to obtain pre-mixed powder.

10. A battery, comprising the fluorine-containing solid-state electrolyte according to claim 1.
